(19) United States
(12) Patent Application Publication
(10) Pub. No.: US 2015/0034888 A1
(43) Pub. Date: Feb. 5, 2015

(54) JACK DEFINING A PORTABLE ACCESSORY FOR REPLACING A MOTOR VEHICLE WHEEL

(71) Applicant: Fiat Group Automobiles S.p.A., Torino (IT)

(72) Inventors: Paolo Mancin, Torino (IT); Antonio Magliocca, Torino (IT)

(73) Assignee: Fiat Group Automobiles S.p.A., Torino (IT)

(21) Appl. No.: 14/448,614

(22) Filed: Jul. 31, 2014

(30) Foreign Application Priority Data
Aug. 1, 2013 (IT) T02013A 000658

(51) Int. Cl. B66F 3/12; B66F 3/22

(52) U.S. Cl. CPC B66F 3/12; B66F 3/22
USPC 254/122

(57) ABSTRACT

A jack, defining a portable accessory for replacing a motor vehicle wheel, is adapted to be placed on the ground and has a scissors-like pantograph provided with a first and a second arm hinged to each other; the first and second arms have respective lower end portions, which can be moved close or away by actuating a screw/nut-screw device; the second arm is shorter than said first arm and is provided with an upper end portion hinged to an intermediate portion of the first arm; the jack further has a supporting member, which is supported only by an upper end of the first arm and can rotate about an axis.

The present invention relates to a jack defining a portable accessory for replacing a motor vehicle wheel.

### BACKGROUND OF THE INVENTION

Some vehicles are provided with a spare wheel and a kit of accessories that can be used directly by the driver, without mechanical workshop assistance, in order to mount the spare wheel in place of a worn or damaged wheel. Among said accessories a jack is comprised. The jack has to placed underneath predetermined points of the vehicle chassis and is manually operated for lifting a part of the chassis and the wheel that must be replaced.

Jacks are known having a lower base adapted to be placed on the ground, a top bracket adapted to support the chassis, and a pantograph defined by four arms arranged so as to form a diamond-like shape. The pantograph has a lower vertex arranged at the base, an upper vertex arranged at the bracket, and two side vertices coupled to one another by way of a screw/nut-screw device. By operating such a device, the two side vertices of the pantograph can be moved close or away, so as to raise or lower the bracket with respect to the base.

A solution of this type, though widely used, has a high overall dimension in the vertical direction, when the bracket is fully lowered, therefore cannot be used in sport type motor vehicles. In fact, in said type of vehicles, the chassis is lowered and/or is provided with aerodynamic side appendixes colloquially called “mini-skirts”, therefore the distance of the chassis from the ground available for the insertion of the jack is extremely limited.

The German utility model DE20313940U1, corresponding to the preamble of claim 1, shows a lifting device having a scissors-like pantograph, therefore more compact than the known solutions described above, but not enough to be suitable for use as a portable accessory for sport type motor vehicles.

### SUMMARY OF THE INVENTION

A purpose of the present invention is to provide a jack defining a portable accessory for replacing a motor vehicle wheel, which allows to fulfill in a simple and economic way the requirements set out above and, preferably, is relatively simple to implement, is relatively lightweight, and has relatively few components.

According to the present invention, a jack defining a portable accessory for replacing a motor vehicle wheel, as defined by claim 1 is provided.

### BRIEF DESCRIPTION OF THE DRAWINGS

The invention will now be described with reference to the accompanying drawings, which illustrate a non-limiting embodiment, wherein:

FIG. 1 shows, in perspective, a preferred embodiment of the jack defining a portable accessory for replacing a motor vehicle wheel, according to the present invention; and

FIG. 2 shows, in enlarged scale, the jack of FIG. 1 in an extended configuration in order to lift a part of the vehicle.

### DETAILED DESCRIPTION OF THE INVENTION

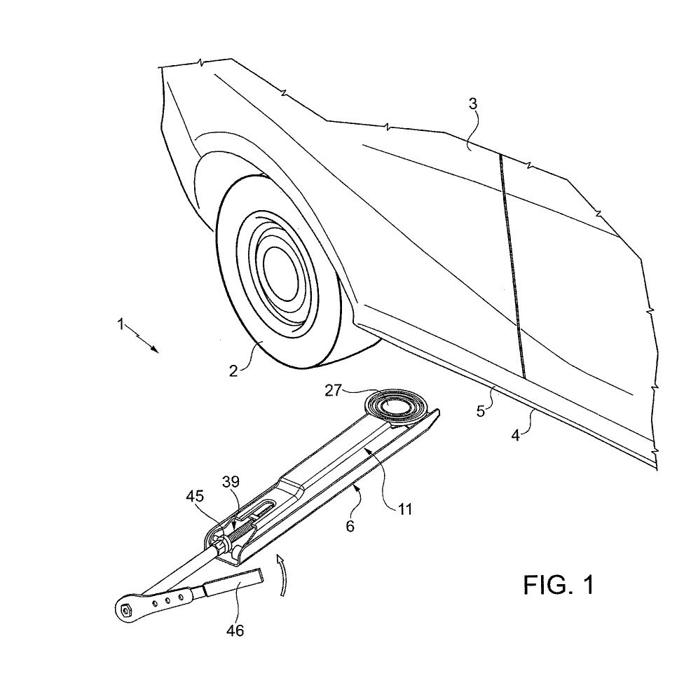

In FIG. 1, number 1 denotes a jack, which defines a portable accessory for replacing a wheel 2 of a motor vehicle 3 (partially illustrated). In other words, the jack 1 constitutes part of a kit of accessories for the mounting of a spare wheel, not shown, and finds advantageous application in sport type motor vehicles 3, i.e. vehicles having a chassis 4 which is lowered and/or is provided with aerodynamic side appendixes 5 colloquially known as “mini-skirts”.

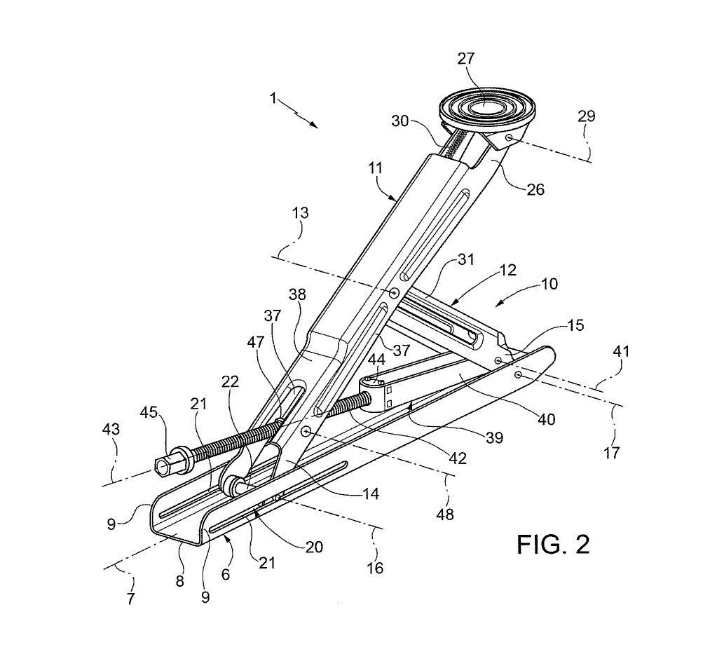

With reference to FIG. 2, the jack 1 comprises a base 6, which is elongated along a horizontal direction 7 and comprises a horizontal wall 8 adapted to be placed on the ground. In particular, in use, the wall 8 is oriented in a direction transverse to the travelling direction of the vehicle 3 (FIG. 1). Preferably, the base 6 is defined by a channel having a U-shaped cross section, comprising two vertical flanges 9, which protrude upwards starting from the longitudinal side edges of the wall 8.

The jack 1 comprises, moreover, a scissor-like pantograph 10, formed by two arms 11,12 hinged to each other about a horizontal axis 13, orthogonal to the direction 7. The arms 11,12 comprise respective lower end portions 14,15, which are coupled to the base 6 in a rotating mode about respective axes 16,17 parallel to the axis 13. One of the two axes 16,17 is fixed with respect to the base 6. The other of the two axes 16, 17 can move along the direction 7 with respect to the base 6, as the corresponding portion 14,15 is coupled in a sliding manner to a horizontal guide 20 carried by the base 6.

In particular, it is the portion 14 of the arm 11 to be coupled to the guide 20. In greater details, the guide 20 is defined by two grooves or slots 21, which are made into the flanges 9 in positions facing one another and are engaged in a sliding manner by the axial ends of a hinge pin 22 that extends along the axis 16.

According to an aspect of the present invention, the arm 11 is longer than the arm 12 and terminates at the top with a portion 26, which supports a plate or bracket 27, adapted to be placed underneath the chassis 4 and supported at predetermined points provided for lifting. In particular, the plate 27 is supported by a single axis 29, defining an abutting axis about which the plate 27 can rotate with respect to the portion 26. Preferably, the axis 29 is parallel to the axis 13. In other words, while resting on the chassis 4, during the lifting, the plate 27 automatically adjusts its angle as a function of the resting conditions, while the angle of the arm 11 varies.

Preferably, the jack 1 further comprises an elastic element 30, for example a helical spring, which connects the plate 27 to the portion 26 so as to maintain the plate 27 at an angular reference position, parallel to the arm 11, when the plate 27 is lowered and/or is not resting on the chassis 4 (FIG. 1).

The plate 27 is supported solely by the arm 11, i.e. disengaged from the arm 12, as the latter terminates at the top with a portion 31 which is hinged to an intermediate portion of the arm 11 about the axis 13.

Preferably, the intermediate portions of the arms 11 and 12 have U-shaped cross sections, i.e. are each formed, by an intermediate wall and by two side flanges, which protrude vertically from the side edges of the corresponding intermediate wall. In the arm 11, the side flanges are denoted by the reference number 37 and the intermediate wall is denoted by the reference number 38. The portions 26 and 14 are defined by the ends of the flanges 37 that protrude beyond the wall 38 in a direction orthogonal to the axes 13,16,17. Preferably, the same arrangement is provided for the portions 15 and 31.

The jack 1 further comprises a screw/nut-screw device 39 which connects the arms 11,12 and is manually operated to make the portion 14 slide along the guide 20 and then to lower/raise the plate 27.

In particular, the device 39 comprises a bracket 40, which is coupled to the portion 15 of the arm 12 so as to remain angularly fixed about the direction 7 and to be angularly rotatable about an axis 41 parallel to axis 17, or eventually coinciding with the axis 17.

The device 39 further comprises a screw 42, which preferably has a right-hand thread, extends along an axis 43 orthogonal to the axes 17 and 41, and has a back end coupled to the bracket 40 by means of a center bearing 44 in order to have, as an only degree of freedom, the rotation about the axis 43. The screw 42 has, then, a front end 45 defining an attachment point for fixing a crank or ratchet handle in a releasable manner 46 (FIG. 1).

The device 39 finally comprises a nut-screw 47, which is screwed on the screw 42 and is coupled to the arm 11 in an angularly fixed manner about an axis 43 and angularly rotatable about an axis 48 which is parallel to the axis 13, is fixed with respect to arm 11 and is advantageously arranged higher than the axis 41. Preferably, the axis 48 is arranged in intermediate position between the axes 13 and 16.

The above defined positions of the constraint points allow to have essentially the following advantages:
the axis 43 varies its inclination with respect to the direction 7 as the angle between the arms 11,12 changes, thus the end 45 progressively moves away from the base 6 during the lifting so as to facilitate the use of the crank or ratchet lever 46 (FIG. 1);
despite the arm 12 being constrained to the device 39 at the axis 41, it is free to rotate about the axis 17 and helps to support the loads applied to the plate 27, by transferring such loads on the base 6 exactly at the axis 17, while the arm 11 transfer them on the axis 16.

With reference to FIG. 1, when the plate 27 is lowered, the jack 1 assumes a closed configuration, wherein the arm 11 houses the arm 12 and, in turn, remains housed between the flanges 9 of the base 6. In particular, the length of the arm 11 is such that the flanges 37 are aligned with the guide 20 in the closed configuration. Also in this closed configuration, the device 39 remains housed in a cavity defined at the top and at the side by the arms 11,12 and at the bottom by the wall 8, except for the free end 45, which remains accessible above the pin 22.

By operating the device 39 by means of the crank 46, with left-hand rotation, the portion 14 is pushed towards the arm 12 and the jack 1 tends to assume an extended configuration (FIG. 2) wherein the axis 16 approaches the axis 17 and the plate 27 is raised to lift, in turn, the chassis 4.

From the foregoing it appears obvious how the jack 1, in the closed configuration, has an extremely limited overall dimension in the vertical direction and therefore can be inserted below the chassis 4 in an easy manner to locally raise the motor vehicle 3, and perform the wheel 2 replacement operations.

Also, thanks to the reduced dimensions, the jack 1 can be housed and transported easily in a special accessories compartment (not shown) of the motor vehicle 3. The jack 1 is extremely compact and lightweight also for the fact that the plate 27 and the arm 12 can be designed to have relatively small overall dimensions.

Despite the simplicity and lightness of the jack 1, the characteristics of its components are such as to provide a relatively high rigidity and resistance.

Furthermore, the plate 27 is oriented automatically about the axis 29 during the lifting, so as to obtain a stable support against the chassis 4, regardless of the lifting degree of the pantograph 10.

As mentioned above, the positions of the attachment points provided on the arms 11,12 for the device 39 allow primarily to obtain a variation in the angle of the axis 43 that during the lifting progressively facilitates the maneuvering of the crank or ratchet lever 46.

The base 6 provides safe rest with respect to rough terrain and acts as a guide on the arm 11, thus increases the breakdown resistance of the arms 11,12 of the pantograph 10. Finally, from the above, it is evident that the jack 1 described can be subject to modifications and variations which do not depart from the scope of protection of the present invention, as defined by the attached claim.

For example, the plate 27 could be replaced by a support element having a different shape and/or size; and/or the device 39 could be coupled to the arms 11,12 at attachment points different from those indicated by way of example.

The base 6 may be reduced in longitudinal dimensions or completely replaced by wheels or rollers which are arranged at the axes 16 and/or 17 and define resting points movable on the ground.

Finally, the components of the jack 1, although normally made of metallic material, could be made of different materials.

1. A jack defining a portable accessory for replacing a motor vehicle wheel; the jack comprising:
resting means adapted to be placed on the ground;
a scissor-like pantograph comprising a first and a second arm hinged to each other about a first axis and comprising a first and, respectively, a second lower end portion; said first and second lower end portions being supported by said resting means and being movable with respect to each other along a horizontal direction orthogonal and skew with respect to said first axis;
a supporting member coupled to an upper end of said pantograph and adapted to be placed underneath said motor vehicle; and
a screw/nut-screw device, which connects said first and second arm, is adapted to be operated to move said first and second lower end portions close or away along said horizontal direction and comprises:
a) a screw, which extends along a second axis orthogonal and skew with respect to said first axis and is coupled to said second lower end portion so as to be rotatable about said second axis and so as to be rotatable about a third axis parallel to said first axis, and
b) a nut-screw, which is screwed on said screw about said second axis and is coupled to said first lower end portion in an angularly fixed manner about said second axis and in a rotatable manner about a fourth axis; said fourth axis being parallel to said first axis and being arranged higher than said third axis;
characterized in that:
said second arm is shorter than said first arm and comprises an upper end portion hinged to an intermediate portion of said first arm about said first axis;
said supporting member is supported only by the upper end of said first arm and is rotatable about a fifth axis with respect to said upper end;
said fourth axis is fixed with respect to said first lower end portion (14).

2. The jack according to claim 1, characterized in that said fifth axis is parallel to said first axis.

3. The jack according to claim 1, characterized by comprising elastic means which connect said supporting member to said upper end for taking said supporting member to an angular reference position with respect to said first arm under inactive condition.

4. The jack according to claim 1, characterized in that said screw has a front end defining an attachment point for fixing a crank or ratchet handle in a releasable manner.

5. The jack according to claim 1, characterized in that said first and second arms comprise respective intermediate portions having U-shaped cross section.
